(19) United States
(12) Patent Application Publication
(10) Pub. No.: US 2018/0261084 A1
(43) Pub. Date: Sep. 13, 2018

(54) APPARATUS AND METHOD FOR DETECTING TEMPERATURE AND OCCUPIED STATUS OF SPACE

(71) Applicant: Chi-Hsiung TSAI, New Taipei City (TW)

(72) Inventor: Chi-Hsiung TSAI, New Taipei City (TW)

(21) Appl. No.: 15/828,437

(22) Filed: Dec. 1, 2017

Related U.S. Application Data
(60) Provisional application No. 62/470,328, filed on Mar. 12, 2017.

(51) Int. Cl. G08G 1/065; G01K 1/02; H04B 17/318

(52) U.S. Cl. CPC G08G 1/065; H04B 17/318; G01K 1/024

(57) ABSTRACT

The invention discloses apparatus and method monitor the occupied status in a finite space. With special deployment of a plurality of specific RF modules, the objects and space occupied status in a finite space can be monitored and delivered to far distance by RF signal in real time. User can search to realize the status through the APP of smartphone.

### CROSS REFERENCE TO RELATED APPLICATIONS

This application claims priority of U.S. provisional Application Ser. No. 62/470,328 entitled “Apparatus and method for detecting temperature and occupied status of space”, filed on Mar. 12, 2017.

### FIELD OF THE INVENTION

The present invention relates to wireless device and methods for detecting the objects distributed in a finite space and transmits by radio frequency (RF) transmission that adapts to collect data of system such as car parking system or security/fire alarm warning system.

### BACKGROUND OF THE INVENTION

The traditional methods for detecting objects in space are illustrated as following: 1.) Active method: using camera to record or using ultrasonic sensor to detect the distance change reflected by object or transmitting infrared and receiving reflection signals to understand whether the space has objects or not. This scheme is used by most smart parking lot. 2.) Passive method: the object transmitting a specific infrared; the sensor receiving and determining the presence of object, or the weight of object sensed by the pressure sensor. Various methods have their limitations and difficulties in implementation and collection of sensors data by wired or additional wireless devices will face the complexity of layout, cost and power consumption etc. There is no system and overall approach detecting the objects by the RSSI signal of radio frequency (RF) in a finite space. The RSSI signal will attenuate by obstacle, it can be used to detect object/space after filtering out the noise appearing in the space.

The mainstream of wireless transmission technology including WIFI, ZigBee and Bluetooth etc. A short distance (100 m or less) wireless transmission scheme using 2.4 GHz public RF spectrum has been widely used in fields as data transmission and communication applications. There is beacon application for indoor positioning with WIFI, ZigBee and Bluetooth, but there is no specification and application of objects detection in finite space. The present invention “Apparatus and method for detecting temperature and occupied status of space” are RF devices and methods for detecting spatial objects (or also including temperature information) and transmit the detection result to far distance RF devices by RF signal. It also provides effective solution of finding object indirectly in a finite space by these RF device's ID or coordinate.

The network topology of ZigBee can support star/mesh network but WIFI and Bluetooth only supports star network now. Long distance transmission requirement needs to define mesh network topology by application itself if they only support star topology like WIFI, Bluetooth.

The RF device can use the broadcast and scan methods which support by most wireless/RF standards to transmit and receive data between wireless endpoints or works as center and peripheral roles concurrently to transmit and receive data between wireless endpoint if it's Bluetooth device. Data can be transmitted to a long distance gateway through the indirect multi-hop transmission or simply direct peer to peer transmission by long range sub-GHz RF if it can achieve. For the mesh network topology, the router mechanism can help transmit data from one node to another node by user defined and implemented routing table. Consequently, by properly defining network topology and using methods of transmitting and receiving data between nodes, data of a node can deliver to any node in the wireless/RF local network.

### SUMMARY OF THE INVENTION

This present invention provides RF modules and methods for detecting objects in a finite space. It can apply to collect sensor data or control devices through RF modules, possible applications such as parking lot management system, intrusion, rescue, fire alarm system etc.

The invention provides an apparatus for detecting occupied status of a finite space, the apparatus comprising: a plurality of radio frequency (RF) modules and each of the RF modules configured to detect objects existing or leaving between RF modules in the finite space according the change of RSSI value received from at least one of the RF modules and a determination whether the RSSI value is within a predefined threshold range and transmits detected result.

More particularly, the communication methods between RF modules includes broadcasting the data of detecting objects number, accumulated objects number, scanning to detect objects between them and receiving the detected objects number of other RF modules and accumulating with the objects number it detected.

More particularly, the data of transmission include the IDs of transmitting and receiving RF module, result of object detecting between the RF modules and the sum of detected objects.

More particularly, an RF device allows sending and receiving data to these RF modules looking for an object by recording IDs of nearby RF modules around object and later navigates to the location of object by scanning IDs of the RF modules and the recorded ID on the deployment map of the RF modules.

More particularly, the object detection and long range transmission RF frequency of the RF module can be the same or different RF standard.

More particularly, the RF module is active/passive RFID tag or includes RFID reader which judges object exist or not by the change of RSSI value between it and the RFID tag.

More particularly, the speed of object can be measured by an RF module which detects the object exist at time T₁ and then at time T₂ the object passes point A and point B that between the RF module and another two RF modules respectively to obtain the speed S of object S=D/(T₂−T₁), where D is the distance between point A and point B.

More particularly, the predefined threshold range of object detection is a wide range and can define more threshold ranges to distinguish the different states of object if the object is composed of smaller separable objects.

Besides there also provides method of building a network comprising a plurality of RF modules. The method includes providing a network comprising a plurality of RF modules as hop nodes, each RF module transmitting data including ID of transmitting/receiving RF module, data of itself and data received from specified nearby left and right RF modules but filtering out data having transmitted through it as bidirectional linear or circular path of data transmission and terminating forwarding data according to an ID of the left RF module that identifies the source of data been received from right RF module or according to an ID of the right RF module that identifies the source of data been received from left RF module.

More particularly, the communication methods between the RF modules include scanning devices to receive data from others and broadcasting data to others.

More particularly, the RF modules are Bluetooth devices and the communication methods between the RF modules include playing the center and peripheral roles to receive the data from others and transmit data to others.

More particularly, the data of transmission include the IDs of transmitting and receiving RF module and sensing data or control data.

More particularly, an object accompanying an RF device allows sending and receiving data to the RF modules, the RF device looking for an object/area by recording IDs of nearby RF modules around object/area and later navigates to the location of object/area by scanning IDs of the RF modules and the recorded ID on the deployment map of the RF modules.

More particularly, an object itself attached an RF device and/or an RF device allows sending and receiving data to these RF modules, locate of object attached with an RF device indirectly by collecting and sending data of the location coordinate of the RF module, object ID information and RSSI value received from the RF device attached to object that are transmitted/received by each of RF modules/RF devices.

Besides that also provide method of monitoring a parking lot by a network comprising a plurality of RF modules around or within the parking spaces, each of the RF modules sending an RF signal across a unit area configured to park one of the vehicles, the RF module detecting an existence of a vehicle on the unit area according to the RSSI value whether the RSSI value is within a threshold range and transmitting detected free/occupied number of spaces/vehicles in the parking lot.

By the disclosure of present invention, any similar RF device which has the ability of data transmission or reception can follow the present invention to archive the functions of invention. It can transmit not only sensor data but also control data by deploying many RF modules to form a wireless RF network.

### BRIEF DESCRIPTION OF THE DRAWINGS

FIG. 1 is a layout/deployment view in accordance with one of embodiments of the present invention; and

FIG. 2 is the implement steps in accordance with the present invention; and

FIG. 3 is the RF modules transmit/receive signal obstructed by object.

### DETAILED DESCRIPTION OF THE INVENTION

The following embodiments are described in accordance with the attached drawings to achieve the above-described objects, characteristics, technical solutions and functions.

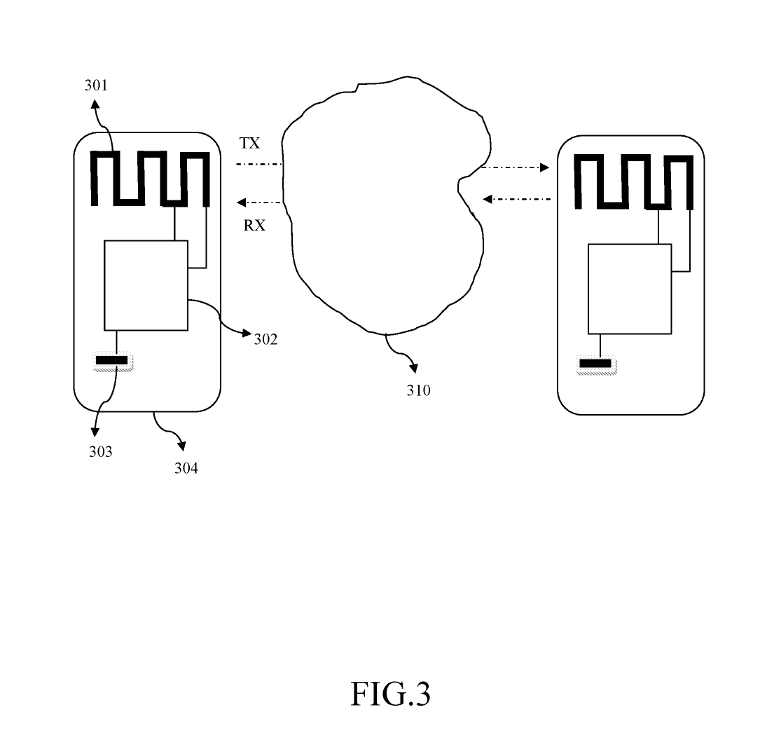

FIG. 3 is a schematic view showing the apparatus for detecting occupied status of a finite space, hereinafter the apparatus is referred to detecting/transceiver apparatus. As shown this figure, the detecting apparatus comprises a plurality of RF modules (also can be referred to as wireless modules) 304 communicate with each other directly or indirectly through a local area network. The RF module 304 of the present invention includes a temperature sensor 303, an RF controller 302 and a transceiver antenna 301, where the RF controller 302 is operatively connected to the temperature sensor 303 and the transceiver antenna 301. The RF controller 302 further detects that at least one object (for example, one object) exists in the area between two adjacent RF modules 304 (namely, a transmitting RF module and a receiving RF module) when the RSSI value of the detected signal is within a preset threshold range. Alternatively, the RF controller 302 further detects that an object leaves the area between two adjacent RF module 304 if the existence state change. The RF controller 302 filters out noise of received signal strength indication RSSI. Afterward, based on the change of RSSI value and detected RSSI value, the RF controller 302 determines whether the RSSI value is within a preset threshold range. In an exemplary example, the RSSI signal received by the RF module 304 (after noise filter out) changes from −50 dBm to −75 dBm due to the existence of the object 310, where the value −75 dBm is within the threshold range defined here as from −72 dBm to −82 dBm, then the RF module 304 detects target object 310 exist. This detected result is also transmitted to outside. However, the above described RSSI signal strength (either the object exists or not) and the threshold range are exemplary and not intended to limit the scope of the present invention. The RF controller 302 can also read the temperature data from the temperature sensor 303 and transmits the read result to outside. The RF controller 302 can receive and transmit any package data to any RF device with the same RF standard, and accept or reject the package data according the condition, package format. For example, the RF controller 302 uses the ID of devices (stored in RF module) or special package header data bytes 0x1EFFB4 to identify and accept/reject devices, where the way of identification, accepting and rejection are defined by the code of application. Provisional RF devices having same RF standard not included in network beforehand can receive and/or send data to the RF module 304 and the data can be accepted if they follow the rules of accepting defined by the code of application.

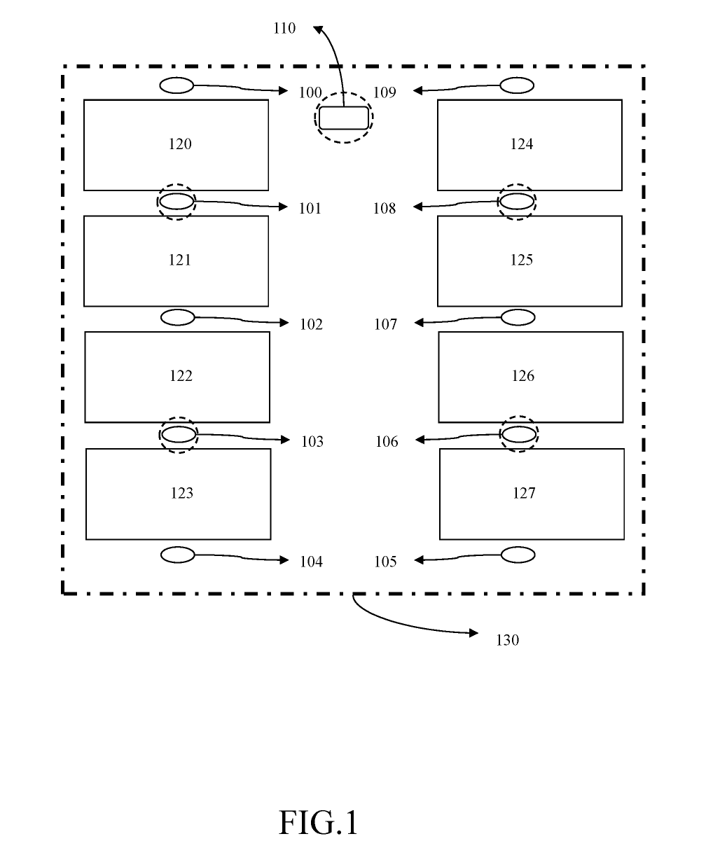

Referring to FIG. 1, this figure shows a schematic view of an exemplary deployment of present invention. The whole local network includes a plurality of RF modules (such as the RF modules 304 shown in FIG. 3) and the RF modules are denoted as unit 100 to unit 109 in FIG. 1, and an RF gateway unit 110 which also can communicate with other RF modules. In FIG. 1 there are totally N=11 nodes, namely RF module unit 100 to unit 109 plus the RF gateway unit 110. These RF modules work together to detect the objects and temperature distribution in some area units (for example, area unit 120 to area unit 127 shown in FIG. 1) within the finite space 130, and this information will transmit to a remote server (not shown) through a gateway unit 110. The communication methods between wireless modules use broadcasting and scanning methods without connecting, or use playing the center and peripheral roles at the same time by connecting each other defined by the functions of the RF controller 302. Once the network of the RF controller 302 supports mesh topology then nodes can communicate with each other directly or indirectly. In the present invention, the architecture/layout of the entire RF local network is first arranged according the monitoring area. Afterward, the required amount (for example N=11) of the RF modules is set up and their ID and location around the areas of monitoring are assigned. Moreover, the present invention chooses M=5 nodes 101, 103, 106, 108, 110 (each marked a circular dash-line in FIG. 1) out of 11 nodes as hop nodes to form a bidirectional linear (the RF module 103 and the RF module 106 disallow to communicate each other) or circular/ring (the RF module 103 and the RF module 106 allow to communicate each other) path. The present invention uses the “left” (counterclockwise) direction and the “right” (clockwise) direction to indicate the bidirectional data transmission, as the propagation path of data flow that all the data of nodes will transmit to routing path directly or indirectly. These nodes also can communication with the gateway unit 110 by peer to peer connection if these nodes have long range RF transmission capability.

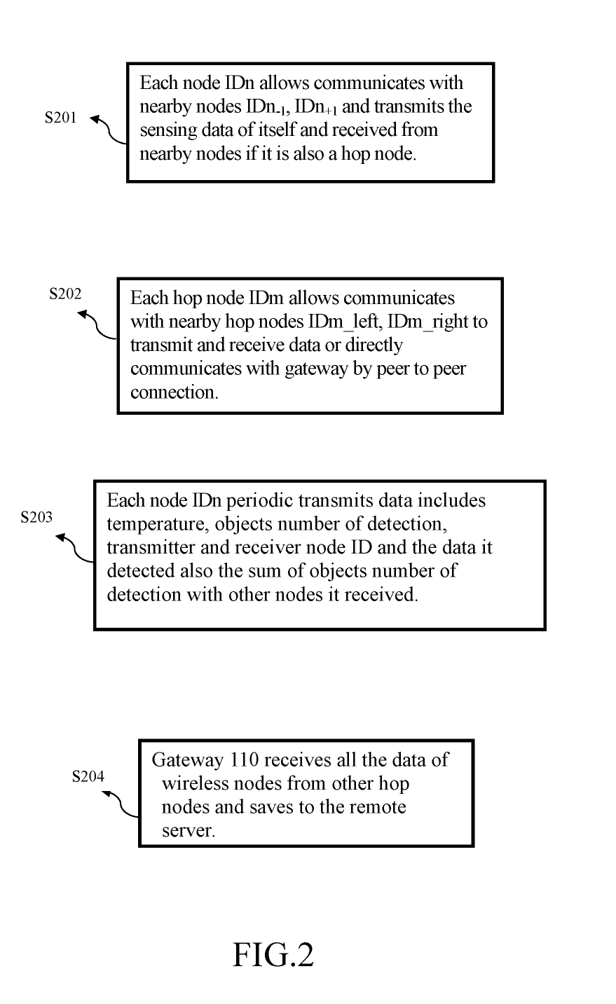

FIG. 2 is the implementation steps describing as follows, Step S201: Each of the RF modules IDn allows to communicate with the nearby RF modules IDn₋₁,IDn₊₁ according to its location. Each of the RF modules IDn transmits data created by itself and also the received data from nearby RF modules if the receiving RF module is also as a hop node. However, the RF module IDn filters out those data transmitted through it but returned back by nearby nodes, as the one-way direction of data transmission. Specifically as the example of FIG. 1, the RF module 100 allows to communicate with the RF module 101 each other, the RF module 101 allows to communicate with the RF modules 100,102 each other, the RF module 102 allows to communicate with the RF modules 101,103 each other, the RF module 103 allows to communicate with the RF modules 102,104 each other, the RF module 104 allows to communicate with the RF module 103 each other, the RF module 105 allows to communicate with the RF module 106 each other, the RF module 106 allows to communicate with the RF modules 105,107 each other, the RF module 107 allows to communicate with RF modules 106,108 each other, the RF module 108 allows to communicate with the RF modules 107,109 each other, the RF module 109 allows to communicate with the RF module 108 each other.

Step S202: Each hop nodes IDm also allows to communicates with the nearby hop nodes IDm_left, IDm_right, Namely, each hop nodes IDm not only transmits the data it created but also the data received from nearby hop nodes IDm_left and IDm_right (but filters out those data had transmitted through it) as a bidirectional circular (for example, the RF module 103 and the RF module 106 allow to communicate each other, namely a closed loop) or linear (for example, the RF module 103 and the RF module 106 disallow to communicate each other, namely a broken loop) routing path of data stream. Each hop nodes will terminate forwarding data according to the ID of left node that identified the source of data received from the right node, or the ID of the right node that identified the source of data received from the left node. Specifically as the example of FIG. 1, the gateway unit 110 allows to communicate with RF module 101,108 each other, the RF module 101 allows to communicate with the gateway unit 110 and the RF module 103 each other, the RF module 103 allows to communicate with the RF module 101 each other, the RF module 106 allows to communicate with the RF module 108 each other, the RF module 108 allows to communicate with the RF module 106 and the gateway unit 110 each other. Each hopping RF modules, for example the gateway unit 110 will drop the received data without forwarding it if the ID of the received data is the ID of the left RF module 101 that received from the right RF module 108. The gateway unit 110 also will drop data without forwarding it if the ID of the received data is the ID of the right RF module 108 that received from the left RF module 101.

Step S203: Each of the RF modules IDn periodically transmits the sensing data according above description and the sensing data includes temperature, RSSI value, detected objects number, IDs of the receiving RF module and the transmitting RF module that identifies the source of data, also sums objects number of detection together with the objects number detected by other nodes. The object number is detected by determining whether the RSSI value (which has been filtered out noise) is within a preset threshold range.

Step S204: The gateway unit 110 receives all the sensing data of the RF nodes from the hop nodes 101 and 108 that contains temperature and object detection result, IDs of the RF modules in each monitoring area, and the sum of objects number of detection to know the objects and temperature distribution in a finite space 130. Through using the designed APP of a smartphone, the smartphone allows sending and receiving data to these RF modules IDn, which records the node ID of the RF module that detects an existence of object (for example, the car of user). Later the user of the smartphone can look for the object/space and navigate to the location of object (for example, the car of the user) by scanning the IDs of the RF nodes and the recorded ID on the deployment map. Moreover the apparatus of the present invention can also measure the speed of object movement. With reference now to FIG. 1, if the distance between the area units 122 and 123 is D while the RF module 103 detects an object existing at time T₁ and then at time T₂ that object moving from the area unit 122 to the area unit 123, the speed S of the object can be calculated as S=D/(T₂−T₁). Moreover, the RF modules 102,104 can be a passive/active RFID tag and the RF module 103 can include an RFID reader to induce passive RFID tags to receive the tag information and RSSI value from RFID tags. The parking fee of object can be evaluated and transmitted by the RF module 103 from the time that object stayed in an area unit 122 or 123 if another RFID tag is attached on the object (the RFID tag identifies the object and can also be read by the RFID reader). An RF device like smartphone allows sending and receiving data to the RF modules and an object itself attached with an RF device allows sending and receiving data to the RF modules. The object attached with an RF device can be located indirectly by collecting and transmitting data of location coordinate of RF module, object ID information and RSSI value received from the RF device attached to the object as extra payload data of transmission that transmitted/received by each of RF modules/devices in the network.

The allowed communication nodes of each node IDn, in the example are the two nearest nodes IDn₋₁,IDn₊₁. But the communicable (communication-allowable) nodes can be more than two nodes and don't need to transmit any object information if they don't need to detect object and don't need to relay any received data (namely if it's not a hop node). Moreover, the routing path of hop node is bidirectional but it can be multidirectional if it allows more surrounding nodes to communicate each other. The object detection threshold for composite object may be a wide range, which is wider than the object detection threshold for a single body. The object detection threshold for composite object is relative to the object volume, shape and distance with the receiving RF module and is adjustable depending on the application. With the same method as previous example, the present invention can define more threshold ranges to detect the different occupied states if the object is composed of some smaller separable objects (namely, the composite object) and the number of composition changes dynamically. For example an object W is composed by two smaller objects L1 and R1 and sometimes object W only composed by L1 or R1 or both three different states of composition. The present invention can define three threshold ranges to identify these three states of object W.

Based on the above descriptions the whole sensing data, objects/spaces detected number and temperature in a finite space can be accessed by any hop node in the routing path and also can be accessed from remote server through the gateway to provide real time information of the space.

In the present invention, the RF modules can not only adopt the public RF specification using the ISM band (Industrial Scientific Medical Band) 2.4 GHz frequency spectrum like Bluetooth/ZigBee/WIFI but also adopt other ISM frequency band alone or together. Besides using the RSSI as the source of determining object exist or not, there are other RF signal index defined by different RF specifications. For example, LQI (Link Quality Index) defined in the 802.15.4 specification and SNR (Signal-to-Noise Ratio) defined in the WIFI 802.11 specification can also be used alone or together to determine object exist or not. Those variations should be treated as the modifications of embodiments. In fact any similar RF devices like smartphone etc., which has the ability of RF transceiver can follow the methods of invention to archive the functions of invention. It can transmit not only sensor data but also control data in a finite space by deploying many RF modules to form a wireless mesh network. The whole system becomes monitoring system of parking lot when the object is vehicle, and becomes security/flow monitoring system when the object is people.

The spirit and scope of the present invention can be clearly understood by the above detail descriptions of the prefer embodiments. The embodiments are not intended to limit the scope of the invention. Contrarily, various modifications of the illustrative embodiments, as well as other embodiments of the invention, will be apparent to persons skilled in the art upon reference to this description. It is therefore contemplated that the appended claims will cover any such modifications or embodiments as falling within the true scope of the invention.

What is claimed is:

1. An apparatus for detecting occupied status of a finite space, the apparatus comprising:
a plurality of radio frequency (RF) modules and each of the RF modules configured to detect at least one object existing or leaving between RF modules in the finite space according the change of RSSI value received from at least one of the RF modules and a determination whether the RSSI value is within a predefined threshold range and transmits detected result.

2. The apparatus according to claim 1, wherein communication methods between the RF modules include broadcasting the data of detected objects number, accumulated objects number, scanning to detect objects between the RF modules and receiving the detected objects number of other RF modules and accumulating the detected objects number.

3. The apparatus according to claim 1, wherein the data of transmission of RF module include IDs of the transmitting RF module and the receiving RF module, RSSI value received by the receiving RF module, result of object detected between the RF modules and the sum of detected objects.

4. The apparatus according to claim 1, wherein an RF device is configured to send and receive data to these RF modules and to look for an object by recording the IDs of the nearby RF modules around the object, the RF device is configured to navigate to a location of object by scanning IDs of RF modules and the recorded ID on a deployment map of the RF modules.

5. The apparatus according to claim 1, wherein the RF modules use object detection RF frequency and long range data transmission RF frequency, which are the same RF standard or different RF standards.

6. The apparatus according to claim 1, wherein the RF module is passive/active RFID tag or includes an RFID reader which determines object exist or not by the change of RSSI value between the RFID reader and an RFID tag.

7. The apparatus according to claim 1, wherein the apparatus is configured to measure a speed of the object by using an RF module which detected the object exist at time T₁ and T₂ when object passes point A and point B that between the RF module and another two RF modules respectively to obtain the speed S of object S=D/(T₂−T₁), where D is the distance between point A and point B.

8. The apparatus according to claim 1, wherein the predefined threshold range of object detection is a wide range and define more threshold ranges to distinguish the different states of object if the object is composed of smaller separable objects.

9. A method for detecting occupied status of a finite space, the method comprising:
providing a network comprising a plurality of RF modules as hop nodes, each of the RF modules transmitting data including ID of transmitting/receiving RF module, data of itself and data received from specified nearby left and right RF modules but filtering out data having transmitted through it as bidirectional linear or circular path of data transmission and the RF module terminating forwarding data according to an ID of the left RF module that identifies the source of data been received from right RF module or according to an ID of the right RF module that identifies the source of data been received from left RF module.

10. The method according to claim 9, wherein the communication methods between the RF modules include scanning devices to receive data from others and broadcasting data to others.

11. The method according to claim 9, wherein the RF modules are Bluetooth devices and the communication methods between the RF modules include playing the center and peripheral roles to receive the data from others and transmitting data to others.

12. The method according to claim 9, wherein the data of transmission include the IDs of the transmitting RF module and the receiving RF module, sensing data and/or control data.

13. The method according to claim 9, wherein an object accompanying an RF device allows sending and receiving data to the RF modules and the RF device looks for the object or an area by recording IDs of nearby RF modules around the object/area, the RF device later navigates to a location of the object/area by scanning IDs of the RF modules and the recorded ID on a deployment map of the RF modules.

14. The method according to claim 9, wherein an object attached with an RF device and/or an RF device allow to send and receive data to the RF modules, locate the object attached with an RF device indirectly by collecting and sending data of location coordinates of the RF modules, object ID information and RSSI value received from the RF device attached to the object, wherein the data of location coordinates of the RF modules, the object ID information and the RSSI value are received and/or transmitted by each of the RF modules and the RF devices.

15. A method for detecting occupied status of a finite space, the method comprising:
monitoring a parking lot by a network comprising a plurality of RF modules around the parking spaces,
each of the RF modules sending an RF signal across a unit area configured to park one of the vehicles, the RF module detecting an existence of a vehicle on the unit area according to the RSSI value whether the RSSI value is within a threshold range and transmitting detected free/occupied number of spaces/vehicles in the parking lot.
